(19) United States
(12) Patent Application Publication
(10) Pub. No.: US 2015/0350468 A1
(43) Pub. Date: Dec. 3, 2015

(54) AUTOMATIC DETECTION OF RECENTLY USED MULTIFUNCTION PERIPHERAL

(71) Applicants: Toshiba Tec Kabushiki Kaisha, Tokyo (JP); Kabushiki Kaisha Toshiba, Tokyo (JP)

(72) Inventor: Marianne Kodimer, Huntington Beach, CA (US)

(21) Appl. No.: 14/292,153

(22) Filed: May 30, 2014

(51) Int. Cl. H04N 1/00

(52) U.S. Cl. CPC H04N 1/00413; H04N 2201/0094

(57) ABSTRACT

Systems and methods for automatic detection of a recently used multifunction peripheral are disclosed. The method comprises receiving user interaction, on a mobile device, initiating a document processing operation, identifying a multifunction peripheral that was most recently used and that is capable of performing the document processing operation as a default multifunction peripheral, and identifying other previously-used multifunction peripherals that are capable of performing the document processing operation as alternative multifunction peripherals. The method further includes presenting, on the mobile device, an interactive menu enabling user selection of a multifunction peripheral to perform the document processing operation, receiving user interaction selecting a multifunction peripheral, and sending instructions to the selected multifunction peripheral to begin the document processing operation.

### BACKGROUND

1. Field

This disclosure relates to user interfaces for mobile devices used in conjunction with multifunction peripherals.

2. Description of the Related Art

A multifunction peripheral (MFP) is a type of document processing device which is an integrated device providing at least two document processing functions, such as print, copy, scan and fax. In a document processing function, an input document (electronic or physical) is used to automatically produce a new output document (electronic or physical).

Documents may be physically or logically divided into pages. A physical document is paper or other physical media bearing information which is readable unaided by the typical human eye. An electronic document is any electronic media content (other than a computer program or a system file) that is intended to be used in either an electronic form or as printed output. Electronic documents may consist of a single data file, or an associated collection of data files which together are a unitary whole. Electronic documents will be referred to further herein as documents, unless the context requires some discussion of physical documents which will be referred to by that name specifically.

In printing, the MFP automatically produces a physical document from an electronic document. In copying, the MFP automatically produces a physical document from a physical document. In scanning, the MFP automatically produces an electronic document from a physical document. In faxing, the MFP automatically transmits via fax an electronic document from an input physical document which the MFP has also scanned or from an input electronic document which the MFP has converted to a fax format.

MFPs are often incorporated into corporate or other organization's networks which also include various other workstations, servers and peripherals. An MFP may also provide remote document processing services to external or network devices.

Increasingly, users have access to mobile devices, such as mobile telephones, tablets, and mobile computers, and wish to interact with MFPs that are available to them to accomplish tasks. The capabilities and processing power of mobile devices sometimes exceed those available on the MFP itself. As such, user interface tasks and tasks which utilize network access, either for the MFP or in order to perform a function involving transmission or storage of the resulting document may rely upon the mobile device used, rather than direct interaction or operation by the MFP.

### DESCRIPTION OF THE DRAWINGS

FIG. 1 is a diagram of an MFP system.

FIG. 2 is a block diagram of an MFP.

FIG. 3 is a block diagram of a computing device.

FIG. 4 is a block diagram of a software system for an MFP.

FIG. 5 is a mobile device user interface showing document processing operations.

FIG. 6 is a mobile device user interface showing a selected document processing operation and a selected default multifunction peripheral for performing the selected document processing operation.

FIG. 7 is a mobile device user interface showing a selected document processing operation and a group of alternative multifunction peripherals for performing the selected document processing operation.

FIG. 8 is a mobile device user interface showing device discovery options.

FIG. 9 is a flowchart for the operation of mobile device software.

Throughout this description, elements appearing in figures are assigned three-digit reference designators, where the most significant digit is the figure number where the element is introduced, and the two least significant digits are specific to the element. An element that is not described in conjunction with a figure may be presumed to have the same characteristics and function as a previously-described element having the same reference designator.

### DETAILED DESCRIPTION

Performing document processing operations directly from a mobile device enables users to avoid the inconvenience of moving documents from the mobile device to a computer suitably adapted to provide document processing requests to an MFP. In many situations, a user may receive a document at his or her mobile device via email. The user may then wish to print or to fax or store that document in a network or cloud location. In other situations, the user interface and processing powers available to a mobile device may provide a better user experience than is available on an MFP. In addition, a user's mobile device may be with them while taking part in meetings, while in his or her office, while at home, and while far from any MFP.

Because mobile devices are typically small, and touch-based, the user interface experiences must be well-designed to avoid screen clutter and to provide good experiences for users. Extraneous settings and options are typically hidden. However, because most mobile devices are capable computing devices, user interfaces can be designed in such a way to make the most important options or the most important options given a particular situation or workflow, most obvious.

Description of Apparatus

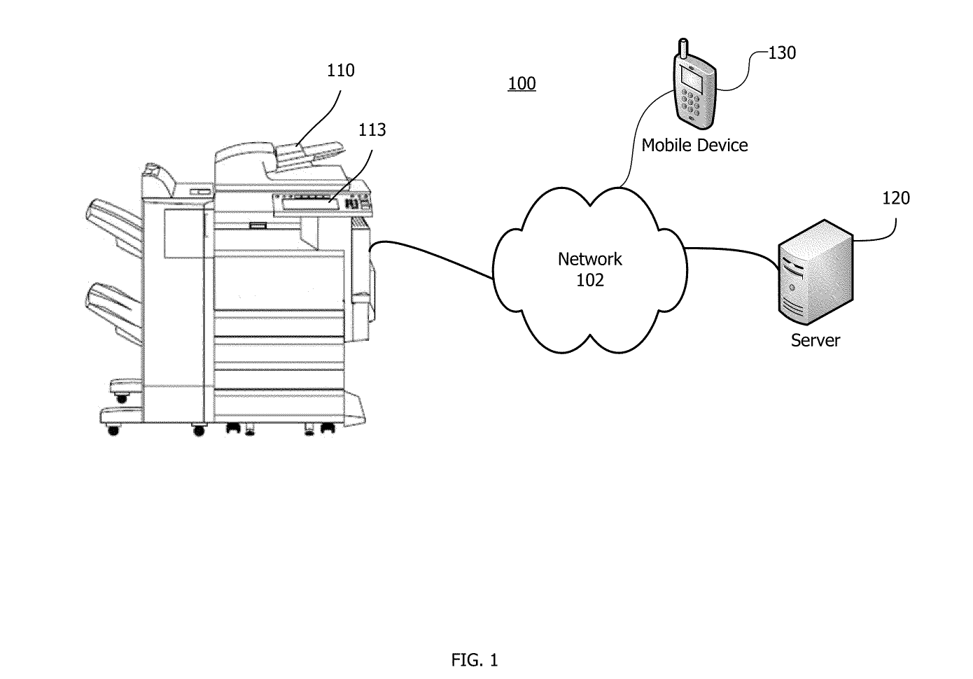

Referring now to FIG. 1 there is shown an MFP system 100. The system 100 includes an MFP 110, a server 120, and a mobile device 130, all interconnected by a network 102. The system 100 may be implemented in a distributed computing environment and interconnected by the network 102. An MFP system may include more than one MFP, more than one server, and more than one mobile device.

The network 102 may be a local area network, a wide area network, a personal area network, a mobile or telephone network, the Internet, an intranet, or any combination of these. The network 102 may have physical layers and transport layers according to IEEE 802.11, Ethernet or other wireless or wire-based communication standards and protocols such as WiMax®, Bluetooth®, mobile telephone and data protocols, the public switched telephone network, a proprietary communications network, infrared, and optical.

The MFP 110 may be equipped to receive portable storage media such as USB drives. The MFP 110 includes a user interface subsystem 113 which communicates information to and receives selections from users. The user interface subsystem 113 has a user output device for displaying graphical elements, text data or images to a user and a user input device for receiving user inputs. The user interface subsystem 113 may include a touchscreen, LCD display, touch-panel, alpha-numeric keypad and/or an associated thin client through which a user may interact directly with the MFP 110.

The server 120 is software operating on a server computer connected to the network.

The mobile device 130 is a mobile or handheld PC, a tablet or smart phone, a feature phone, smart watch, or other similar device. The mobile device 130 is representative of one or more end-user devices and may be considered separate from the system 100.

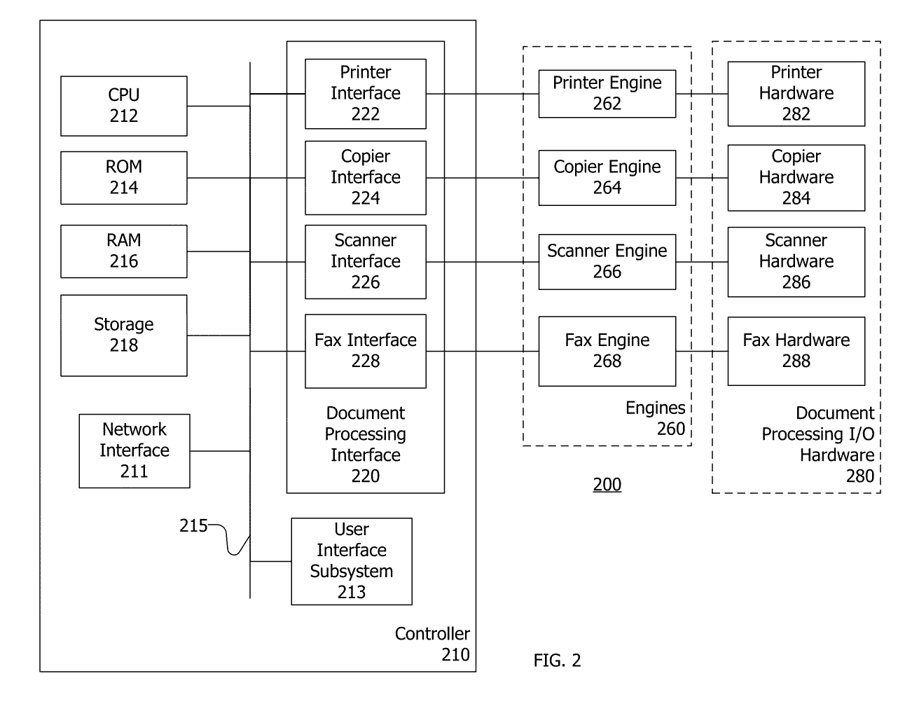

Turning now to FIG. 2 there is shown a block diagram of an MFP 200 which may be the MFP 110 (FIG. 1). The MFP 200 includes a controller 210, engines 260 and document processing I/O hardware 280. The controller 210 includes a CPU 212, a ROM 214, a RAM 216, a storage 218, a network interface 211, a bus 215, a user interface subsystem 213 and a document processing interface 220.

As shown in FIG. 2 there are corresponding components within the document processing interface 220, the engines 260 and the document processing I/O hardware 280, and the components are respectively communicative with one another. The document processing interface 220 has a printer interface 222, a copier interface 224, a scanner interface 226 and a fax interface 228. The engines 260 include a printer engine 262, a copier engine 264, a scanner engine 266 and a fax engine 268. The document processing I/O hardware 280 includes printer hardware 282, copier hardware 284, scanner hardware 286 and fax hardware 288.

The MFP 200 is configured for printing, copying, scanning and faxing. However, an MFP may be configured to provide other document processing functions, and, as per the definition, as few as two document processing functions.

The CPU 212 may be a central processor unit or multiple processors working in concert with one another. The CPU 212 carries out the operations necessary to implement the functions provided by the MFP 200. The processing of the CPU 212 may be performed by a remote processor or distributed processor or processors available to the MFP 200. For example, some or all of the functions provided by the MFP 200 may be performed by a server or thin client associated with the MFP 200, and these devices may utilize local resources (e.g., RAM), remote resources (e.g., bulk storage), and resources shared with the MFP 200.

The ROM 214 provides non-volatile storage and may be used for static or fixed data or instructions, such as BIOS functions, system functions, system configuration data, and other routines or data used for operation of the MFP 200.

The RAM 216 may be DRAM, SRAM or other addressable memory, and may be used as a storage area for data instructions associated with applications and data handling by the CPU 212.

The storage 218 provides volatile, bulk or long term storage of data associated with the MFP 200, and may be or include disk, optical, tape or solid state. The three storage components, ROM 214, RAM 216 and storage 218 may be combined or distributed in other ways, and may be implemented through SAN, NAS, cloud or other storage systems.

The network interface 211 interfaces the MFP 200 to a network, such as the network 102 (FIG. 1), allowing the MFP 200 to communicate with other devices.

The bus 215 enables data communication between devices and systems within the MFP 200. The bus 215 may conform to the PCI Express or other bus standard.

While in operation, the MFP 200 may operate substantially autonomously. However, the MFP 200 may be controlled from and provide output to the user interface subsystem 213, which may be the user interface subsystem 113 (FIG. 1).

The document processing interface 220 may be capable of handling multiple types of document processing operations and therefore may incorporate a plurality of interfaces 222, 224, 226 and 228. The printer interface 222, copier interface 224, scanner interface 226, and fax interface 228 are examples of document processing interfaces. The interfaces 222, 224, 226 and 228 may be software or firmware.

Each of the printer engine 262, copier engine 264, scanner engine 266 and fax engine 268 interact with associated printer hardware 282, copier hardware 284, scanner hardware 286 and facsimile hardware 288, respectively, in order to complete the respective document processing functions.

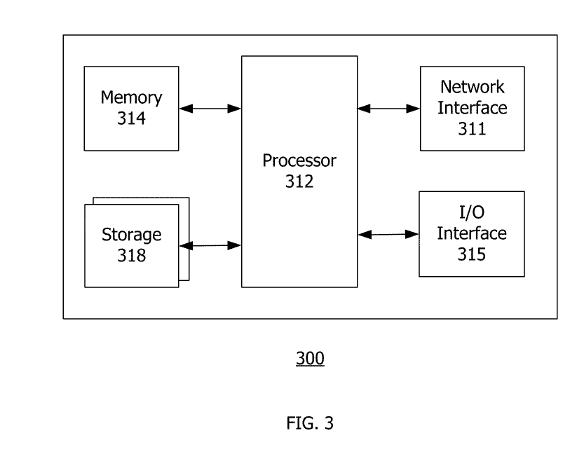

Turning now to FIG. 3 there is shown a computing device 300, which is representative of the server computers, client devices, mobile devices and other computing devices discussed herein. The controller 210 (FIG. 2) may also, in whole or in part, incorporate a general purpose computer like the computing device 300. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 has a processor 312 coupled to a memory 314, storage 318, a network interface 311 and an I/O interface 315. The processor may be or include one or more microprocessors and, application specific integrated circuits (ASICs).

The memory 314 may be or include RAM, ROM, DRAM, SRAM and MRAM, and may include firmware, such as static data or fixed instructions, BIOS, system functions, configuration data, and other routines used during the operation of the computing device 300 and processor 312. The memory 314 also provides a storage area for data and instructions associated with applications and data handled by the processor 312.

The storage 318 provides non-volatile, bulk or long term storage of data or instructions in the computing device 300. The storage 318 may take the form of a disk, tape, CD, DVD, or other reasonably high capacity addressable or serial storage medium. Multiple storage devices may be provided or available to the computing device 300. Some of these storage devices may be external to the computing device 300, such as network storage or cloud-based storage.

The network interface 311 includes an interface to a network such as network 102 (FIG. 1).

The I/O interface 315 interfaces the processor 312 to peripherals (not shown) such as displays, keyboards and USB devices.

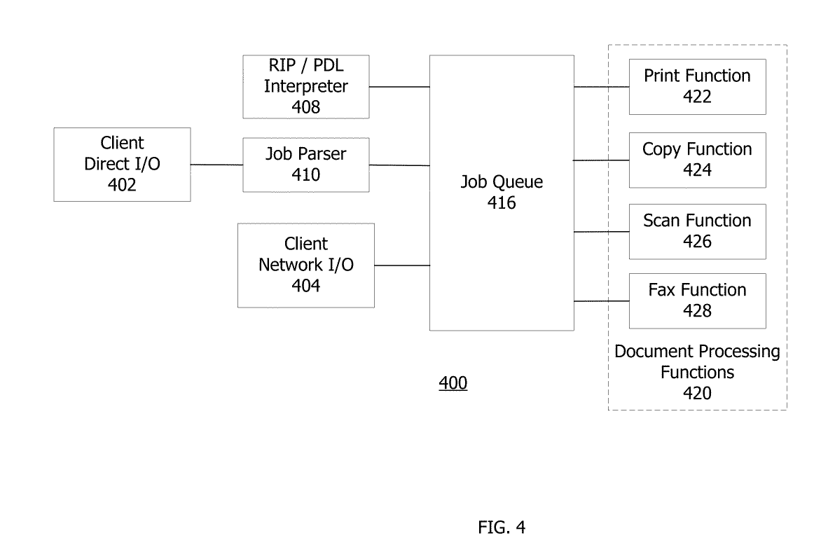

Turning now to FIG. 4 there is shown a block diagram of a software system 400 of an MFP which may operate on the controller 210. The system 400 includes client direct I/O 402, client network I/O 404, a RIP/PDL interpreter 408, a job parser 410, a job queue 416, a series of document processing functions 420 including a print function 422, a copy function 424, a scan function 426 and a fax function 428.

The client direct I/O 402 and the client network I/O 404 provide input and output to the MFP controller. The client direct I/O 402 is for the user interface on the MFP (e.g., user interface subsystem 113), and the client network I/O 404 is for user interfaces over the network. This input and output may include documents for printing or faxing or parameters for MFP functions. In addition, the input and output may include control of other operations of the MFP. The network-based access via the client network I/O 404 may be accomplished using HTTP, FTP, UDP, electronic mail TELNET or other network communication protocols.

The RIP/PDL interpreter 408 transforms PDL-encoded documents received by the MFP into raster images or other forms suitable for use in MFP functions and output by the MFP. The RIP/PDL interpreter 408 processes the document and adds the resulting output to the job queue 416 to be output by the MFP.

The job parser 410 interprets a received document and relays it to the job queue 416 for handling by the MFP. The job parser 410 may perform functions of interpreting data received so as to distinguish requests for operations from documents and operational parameters or other elements of a document processing request.

The job queue 416 stores a series of jobs for completion using the document processing functions 420. Various image forms, such as bitmap, page description language or vector format may be relayed to the job queue 416 from the scan function 426 for handling. The job queue 416 is a temporary repository for all document processing operations requested by a user, whether those operations are received via the job parser 410, the client direct I/O 402 or the client network I/O 404. The job queue 416 and associated software is responsible for determining the order in which print, copy, scan and facsimile functions are carried out. These may be executed in the order in which they are received, or may be influenced by the user, instructions received along with the various jobs or in other ways so as to be executed in different orders or in sequential or simultaneous steps. Information such as job control, status data, or electronic document data may be exchanged between the job queue 416 and users or external reporting systems.

The job queue 416 may also communicate with the job parser 410 in order to receive PDL files from the client direct I/O 402. The client direct I/O 402 may include printing, fax transmission or other input of a document for handling by the system 400.

The print function 422 enables the MFP to print documents and implements each of the various functions related to that process. These include stapling, collating, hole punching, and similar functions. The copy function 424 enables the MFP to perform copy operations and all related functions such as multiple copies, collating, 2 to 1 page copying or 1 to 2 page copying and similar functions. Similarly, the scan function 426 enables the MFP to scan and to perform all related functions such as shrinking scanned documents, storing the documents on a network or emailing those documents to an email address. The fax function 428 enables the MFP to perform facsimile operations and all related functions such as multiple number fax or auto-redial or network-enabled facsimile.

Some or all of the document processing functions 420 may be implemented on a client computer, such as a personal computer or thin client. The user interface for some or all document processing functions may be provided locally by the MFP's user interface subsystem though the document processing function is executed by a computing device separate from but associated with the MFP.

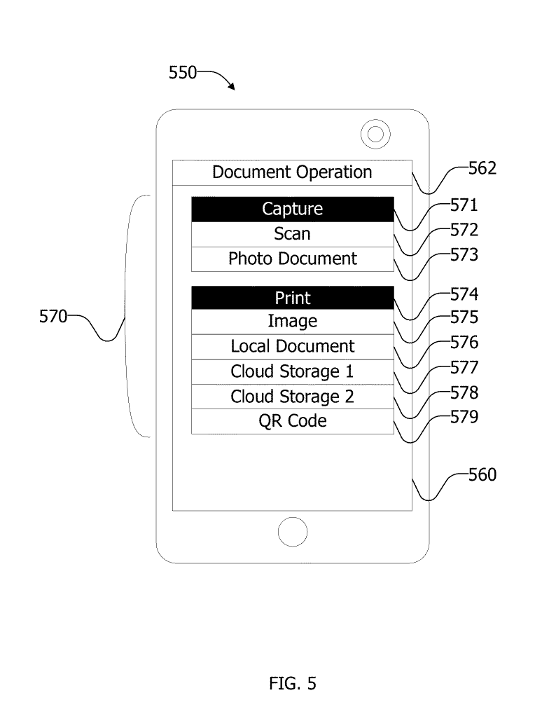

Turning now to FIG. 5, a mobile device 550 user interface 560 showing document processing operations is shown. The mobile device 550 is a computing device, such as that shown in FIG. 2. The user interface 560 is a visual system of interacting with the mobile device 550 presented on a display that may include a touch screen overlay for detecting user touch or similar input. The user interface 560 enables user interaction with the mobile device 550 in order to accomplish tasks using the mobile device 550.

The user interface 560 includes a process identification 562 indicating the process or processes that are being presented. This is shown generically as “document operation” in FIG. 5, but may specifically identify a document processing operation or operations, such as scan, print, facsimile, email, and the like.

A series of document processing operations 570 are shown on the user interface 560. The operations 570 include capture 571 and print 574 operations. Under capture 571, document processing operations of scan 572 and photo document 573 are shown.

The scan 572 operation begins the process of scanning a document. The photo document 573 performs the same general operation, but begins with a photograph on the user's mobile device 550. Once scanned, using either operation, the resulting electronic document can be transmitted to a network location, stored on the mobile device 550, stored in a cloud storage location, output by the MFP by printing or faxing the document, and various other operations can be performed.

The print 574 operation begins the process of printing a document using the MFP. The document may be drawn from any number of locations. These locations include an image 575, for example an image on the mobile device 550. The local document 576 may be a word processing document, slideshow frame, spreadsheet, email, or other document type stored locally (or otherwise available locally) to the mobile device 550.

The cloud storage 1 577 and cloud storage 2 578 are representative of a plurality so-called “cloud” storage locations that provide network storage that is intended to be available to a user “anywhere” he or she has network connectivity. Box®, Dropbox® and Google Drive® are examples of such cloud storage locations that are presently provided by third parties. “Cloud” storage may also be provided by an MFP manufacturer or by a business for its own employees.

Finally, the QR (quick response) code 579 may be used to output a QR code that will uniquely identify an MFP to a device detection algorithm so that, for example, another mobile device may scan the resulting printed QR code to obtain information necessary to access and interact with the MFP to which the printed QR code refers.

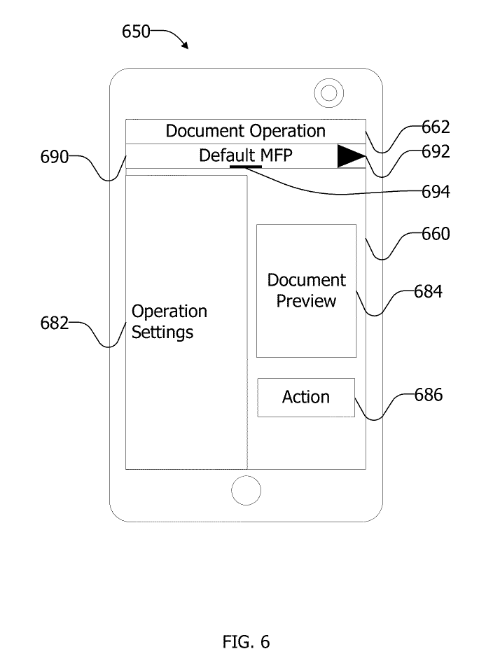

Turning now to FIG. 6, a mobile device 650 user interface 660 showing a selected document processing operation 662 and a selected default multifunction peripheral 690 for performing the selected document processing operation is shown. The mobile device 650 and user interface 660 are substantially the same as those shown in FIG. 5. They will not be discussed again here. The available document processing operations 562 has become the selected document processing operation 662 in FIG. 6.

This user interface 660 is displayed once the user has selected a document processing operation from those operations 570 presented in FIG. 5. For example, the operation may be a scan 572.

Once this operation is selected, the document processing operation settings 682 may be displayed on the user interface 660. These settings 682 may be the default settings and may be editable by any number of methods. A document preview 684, showing a thumbnail image of the document that will result from the selected document processing operation 662 may be shown on the user interface 660. Activation of an action button 686 may cause the mobile device to instruct the default MFP 690 to begin the selected document processing operation 662.

As can be seen, the default MFP 690 is shown on the user interface 660. The default MFP may be selected, for example, as the most recently used MFP, that is currently available to the mobile device 650 and capable of performing the selected document processing operation 662.

A button 692 may enable a user to select from a series of alternative MFPs or may initiate a dialogue to search for additional MFPs not currently known to or detected by the mobile device 650.

A pull down user interface element 694 may enable the user to select from a series of alternative MFPs or may initiate a dialogue to search for additional MFPs not currently known to or detected by the mobile device 650.

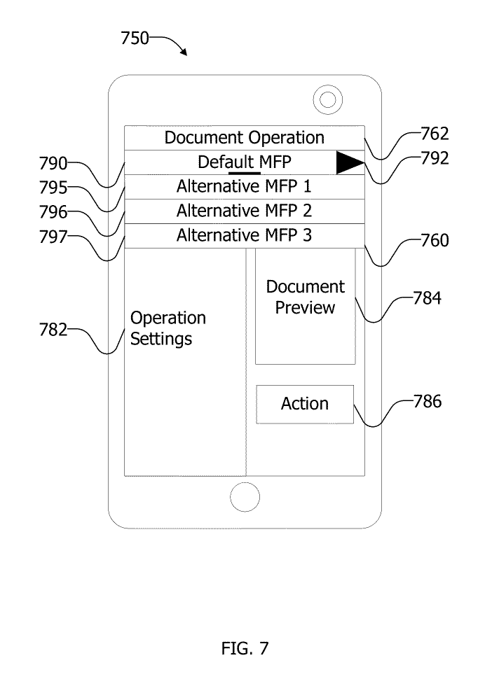

Turning now to FIG. 7, is a mobile device user interface showing a selected document processing operation and a group of alternative multifunction peripherals for performing the selected document processing operation is shown. The mobile device 750, user interface 760, selected document processing operation 762, operation settings 782, document preview 784, and action button 786 are substantially the same as those shown in FIG. 6. They will not be discussed again here.

The default MFP 790 is still visible, but the user interface 760 has been updated to show a series of alternative MFPs 795, 796, and 797. This update may be the result of either user interaction with user interface 760, such as the pull down user interface element 694 or the button 692 in FIG. 6. These alternative MFPs are in addition to the default MFP 790 and are, likewise, recently used, available to the mobile device 750, and capable of performing the selected document processing operation 762.

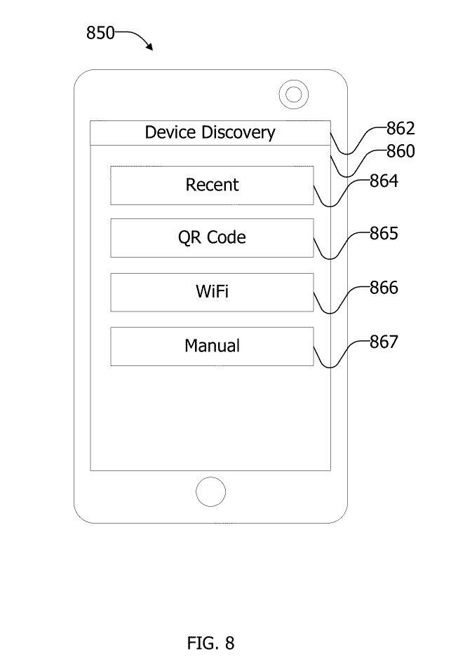

Turning now to FIG. 8, a mobile device user interface showing device discovery options is shown. The mobile device 850 and user interface 860 are substantially the same as those shown in FIG. 6. They will not be discussed again here.

The device discovery screen 862 may be brought up, for example, by user interaction with an element of the user interface 860, such as the pull down user interface element 694 or the button 692 in FIG. 6. This device discovery screen 862 may enable a user to identify an MFP other than those listed as the default MFP 790 or any of the alternative MFPs 795, 796, and 797.

The user may identify another MFP by selecting from a recent list 864 when the list of alternative MFPs 795, 796, and 797 is limited to only a few, recent MFPs, the recent list 864 may present more. The user may scan a QR code after selecting QR code 865, for example affixed to a nearby MFP, visible on a display on the MFP, or on a paper output by the MFP, using a camera in the mobile device 850.

The user may perform an automatic discovery process using wireless networking by selecting WiFi 866. Finally, the user may manually input a uniform resource locator (URL), internet protocol address (IP), or other network address after selecting manual 867.

Once identified by any of these methods, any new MFP may be identified as the new default MFP or otherwise added to the alternative MFPs or recent MFP list.

Description of Processes

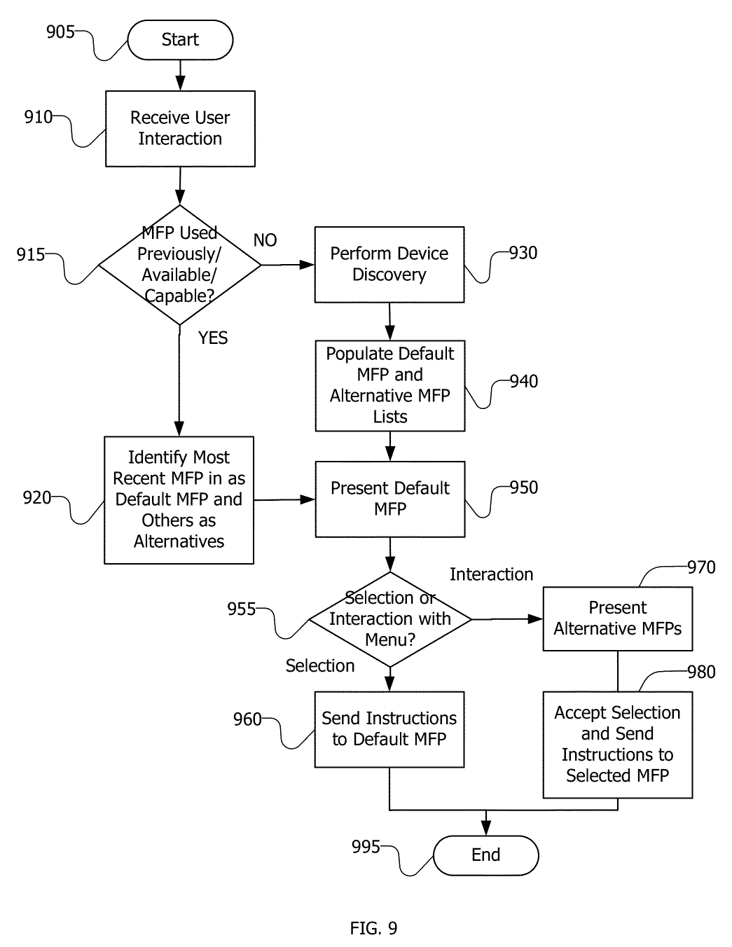

Turning now to FIG. 9, a flowchart for the operation of mobile device software is shown. The flowchart begins at start 905 and ends at end 995. The process may begin once a user has initiated a document processing operation using the mobile device. The processes in the flowchart may repeat or recur any number of times.

As a first step, a user begins interaction with the mobile device, such as mobile device 550, that initiates a document processing operation at 910. This may be an interaction that launches a mobile application on the mobile device and initiates a process that may be controlled or influenced by the mobile application. The document processing operation may be a scan, print, facsimile, email, or other operation that is initiated by a user of a mobile device.

Once the user has selected a document processing operation for completion by an MFP, the mobile device must determine which MFP to utilize for this document processing operation. At 950, a determination may be made whether or not the mobile device has previously used an MFP that is still available and capable of performing the selected document processing operation. If the mobile device has been used in conjunction with at least one MFP to perform a document processing operation recently (“yes” at 915), then the most recently used MFP or MFPs are identified at 920. A default MFP may be identified along with a series of alternative MFPs that were also recently used, are available to the mobile device, and capable of performing the selected document processing operation.

Recently used MFPs may be those that have been accessed and used to complete any document processing operation by the mobile device. This data may be stored on the mobile device or may be stored in an account associated with the mobile device or a user of the mobile device.

MFPs that are available to the mobile device are those that are on a network, accessible to the mobile device, and to which the mobile device (or associated user) has rights to perform a document processing operation (or a specific document processing operation). For example, a user may be allowed to print to only a subset of otherwise available MFPs. Still further, a user may only have color printing privileges on a single MFP from those otherwise available to that user. MFPs to which the user or mobile device does not have rights to use or to use for specific functions are not “available” to the mobile device.

Finally, MFPs that are incapable of performing one or more operations, such as color printing, or color scanning, or cloud storage, will not be listed in any recent MFP list for a document processing operation that involves a capability that that MFP cannot perform.

If any of the conditions of recent use, availability, and capability are not met by any MFP (“no” at 915), then device discovery is performed at 930. This process may conform generally to the process shown in FIG. 8. A user may manually input an address for an MFP, a user may perform an automatic device discovery using methods known in the art, or a user may scan a QR or other code in order to identify an MFP to perform the selected document processing operation.

Once device discovery is complete, the MFP and alternative MFP lists are populated at 940 with the MFP or MFPs that were discovered as a result of the device discovery at 930. These lists may be seen, for example, in FIGS. 6 and 7.

At 950, the default MFP is presented to the user via the user interface of the mobile device. This may be seen in FIG. 6. Although multiple MFPs may have been identified as recent use at 915 or through device discovery at 930, only a single default MFP is displayed at 950 as shown in FIG. 6. An interactive element of the user-selectable menu 694 or a button may enable a user to display the alternative MFPs that were also identified.

At 955, a determination is made whether or not a user has selected the default MFP, for example, by selecting the action button 686 in FIG. 6, or has interacted with the interactive element of the user-selectable menu 694 or button 692 in an effort to view the alternative MFPs as well.

If the user has selected the default MFP (“selection” at 955), then document processing operation instructions are sent to the default MFP at 960 and the associated document processing operation will commence.

If the user has interacted with the interactive element of the user-selectable menu 694 or button 692 in an effort to view the alternative MFPs (“interaction” at 955), then the alternative MFPs are presented to the user on the user interface 660 at 970. The alternative MFP and default MFP simultaneous display is shown in FIG. 7.

The user may then choose from either the default MFP or the alternative MFPs or, still further, manually request device discovery to thereby identify still more MFPs. Once the user has selected, instructions to begin the document processing operation are sent to the selected MFP at 980 and the process ends at 995.

Whatever MFP is selected to perform the document processing operation automatically becomes the most-recently-used MFP and, accordingly, becomes the default MFP at least for that document processing operation. Though the determination is made based upon the most recently used MFP every time a document processing operation is requested by a mobile device, the list is continually updated based upon user interaction with the mobile device.

The most recently used MFP (and thus the default MFP) for scanning may not be the same as the most recently used MFP (and thus the default MFP) for printing. And, as discussed above, some MFPs are incapable of performing certain operations or users are unauthorized to perform certain operations on certain MFPs. In these situations, the default MFP may be different for those operations than for others.

As indicated above, the default MFP and/or alternative MFPs may be stored on the mobile device or stored in the cloud. Therefore, the default MFP and alternative MFPs may be available to a mobile device user while requesting a document processing operation from any mobile device. For example, if a user has multiple mobile devices (e.g. a mobile phone and a tablet). So, long as the user begins a document processing operation using a mobile device (or the user account associated with the cloud-stored default action), the default MFP and alternative MFPs will remain the same and will be updated as changes occur, no matter what MFP the user has selected.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A method for a user of a mobile device to select a multifunction peripheral from a plurality of multifunction peripherals, wherein each of the plurality of multifunction peripherals is not necessarily capable of performing all of a plurality of document processing operations, and the user of the mobile device is not necessarily authorized to perform all of the plurality of document processing operations on all of the plurality of multifunction peripherals, the method comprising:
receiving user interaction, on a mobile device, initiating a user-selected document processing operation from among the plurality of document processing operations;
identifying a multifunction peripheral that was most recently used by the user for the user-selected document processing operation as a default multifunction peripheral;
determining which additional multifunction peripherals, of a plurality of multifunction peripherals, are capable of performing the user-selected document processing operation;
determining which of the additional multifunction peripherals upon which a user of the mobile device is authorized to perform the document processing operation;
identifying those of the additional multifunction peripherals that are capable of performing the user-selected document processing operation and upon which a user of the mobile device is authorized to perform the user-selected document processing operation as alternative multifunction peripherals;
presenting, on the mobile device, an interactive menu enabling the user of the mobile device to select a multifunction peripheral to perform the document processing operation, the menu comprising a user-selectable menu including (1) the default multifunction peripheral visible and selected within the user-selectable menu and (2) a list of the alternative multifunction peripherals available via an interactive element of the user-selectable menu and selectable by a user after interaction with the interactive element of the user-selectable menu;
receiving user interaction, on the mobile device, selecting one of (1) the default multifunction peripheral and (2) one of the alternative multifunction peripherals to thereby identify a selected multifunction peripheral; and
sending instructions to the selected multifunction peripheral to begin the user-selected document processing operation.

2. The method of claim 1 wherein the interactive element is a pull down user interface element and interaction with the pull down user interface element results in display of the entire user-selectable menu including the list of alternative multifunction peripherals.

3. The method of claim 1 wherein the interactive element is a button user interface element and interaction with the button results in display of the entire user-selectable menu including the list of alternative multifunction peripherals.

4. The method of claim 1 further comprising identifying additional multifunction devices, not previously used, that are capable of performing the document processing operation via an automatic discovery process and including the additional multifunction devices as a part of the list of alternative multifunction peripherals.

5. The method of claim 1 wherein the document processing operation is a scan operation directed by user interaction with the mobile device and completed by the selected multifunction peripheral.

6. The method of claim 5 wherein the document resulting from the scan operation is directed for storage on a cloud storage service identified by user interaction with the mobile device and completed by the selected multifunction peripheral.

7. An apparatus, including a processor and associated memory, the apparatus for enabling a user of a mobile device to select a multifunction peripheral from a plurality of multifunction peripherals, wherein each of the plurality of multifunction peripherals is not necessarily capable of performing all of a plurality of document processing operations, and the user of the mobile device is not necessarily authorized to perform all of the plurality of document processing operations on all of the plurality of multifunction peripherals, including software that when executed by the processor causes the processor to:
receive user interaction, on a mobile device, initiating a user-selected document processing operation from among the plurality of document processing operations;
identify a multifunction peripheral that was most recently used by the user for the user-selected document processing operation as a default multifunction peripheral;
determine which additional multifunction peripherals, of a plurality of multifunction peripherals, are capable of performing the user-selected document processing operation;
determine which of the additional multifunction peripherals upon which a user of the mobile device is authorized to perform the document processing operation;
identifying those of the additional multifunction peripherals that are capable of performing the user-selected document processing operation and upon which a user of the mobile device is authorized to perform the user-selected document processing operation as alternative multifunction peripherals;
present an interactive menu enabling the user of the mobile device to select a multifunction peripheral to perform the document processing operation, the interactive menu comprising a menu including (1) the default multifunction peripheral visible and selected within the user-selectable menu and (2) a list of the alternative multifunction peripherals available via an interactive element of the user-selectable menu and selectable by a user after interaction with the interactive element of the user-selectable menu;
receive user interaction, on the mobile device, selecting one of (1) the default multifunction peripheral and (2) one of the alternative multifunction peripherals to thereby identify a selected multifunction peripheral; and
send instructions to the selected multifunction peripheral to begin the user-selected document processing operation.

8. The apparatus of claim 7 wherein the interactive element is a pull down user interface element and interaction with the pull down user interface element results in display of the entire user-selectable menu including the list of alternative multifunction peripherals.

9. The apparatus of claim 7 wherein the interactive element is a button user interface element and interaction with the button results in display of the entire user-selectable menu including the list of alternative multifunction peripherals.

10. The apparatus of claim 7 wherein software, when executed by the processor, causes the processor to identify additional multifunction devices, not previously used, that are capable of performing the document processing operation via an automatic discovery process and including the additional multifunction devices as a part of the list of alternative multifunction peripherals.

11. The apparatus of claim 7 wherein the document processing operation is a scan operation directed by user interaction with the mobile device and completed by the selected multifunction peripheral.

12. The apparatus of claim 11 wherein the document resulting from the scan operation is directed for storage on a cloud storage service identified by user interaction with the mobile device and completed by the selected multifunction peripheral.

13. A mobile device for selecting a multifunction peripheral from a plurality of multifunction peripherals, wherein each of the plurality of multifunction peripherals is not necessarily capable of performing all of a plurality of document processing operations, and the user of the mobile device is not necessarily authorized to perform all of the plurality of document processing operations on all of the plurality of multifunction peripherals, the mobile device comprising:
a user interface for receiving user interaction, on a mobile device, initiating a user-selected document processing operation from among the plurality of document processing operations;
a processor for accessing data stored in memory to identify a multifunction peripheral that was most recently used by the user for the user-selected document processing operation as a default multifunction peripheral
the processor further for accessing data stored in memory to determine which additional multifunction peripherals, of a plurality of multifunction peripherals, are capable of performing the user-selected document processing operation, to determine which of the additional multifunction peripherals upon which a user of the mobile device is authorized to perform the document processing operation; and identify those of the additional multifunction peripherals that are capable of performing the user-selected document processing operation and upon which a user of the mobile device is authorized to perform the user-selected document processing operation as alternative multifunction peripherals;
the user interface for presenting an interactive menu enabling the user of the mobile device to select a multifunction peripheral to perform the document processing operation, the menu comprising a user-selectable menu including (1) the default multifunction peripheral visible and selected within the user-selectable menu and (2) a list of the alternative multifunction peripherals available via an interactive element of the user-selectable menu and selectable by a user after interaction with the interactive element of the user-selectable menu;
the user interface further for receiving user interaction, on the mobile device, selecting one of (1) the default multifunction peripheral and (2) one of the alternative multifunction peripherals to thereby identify a selected multifunction peripheral; and
a network interface for sending instructions to the selected multifunction peripheral to begin the user-selected document processing operation.

14. The apparatus of claim 13 wherein the interactive element is a pull down user interface element and interaction with the pull down user interface element results in display of the entire user-selectable menu including the list of alternative multifunction peripherals.

15. The apparatus of claim 13 wherein the interactive element is a button user interface element and interaction with the button results in display of the entire user-selectable menu including the list of alternative multifunction peripherals.

16. The apparatus of claim 13 wherein the processor further for initiating a search process to identify additional multifunction devices, not previously used, that are capable of performing the document processing operation via an automatic discovery process and including the additional multifunction devices as a part of the list of alternative multifunction peripherals.

17. The apparatus of claim 13 wherein the document processing operation is a scan operation directed by user interaction with the mobile device and completed by the selected multifunction peripheral.

18. The apparatus of claim 17 wherein the document resulting from the scan operation is directed for storage on a cloud storage service identified by user interaction with the mobile device and completed by the selected multifunction peripheral.
